(19) United States
(12) Patent Application Publication
(10) Pub. No.: US 2005/0102932 A1
(43) Pub. Date: May 19, 2005

(54) Modular coffer trim kit and method

(76) Inventors: Gerald J. MacKey, Lehigh Acres, FL (US); Anthony R. Tomei, Ft. Myers Beach, FL (US); Jeffrey Kossow, Lehigh Acres, FL (US)

Correspondence Address: Edward M. Livingston, 963 Trail Terrace Drive, Naples, FL, 34103, US

(21) Appl. No.: 10/712,243

(22) Filed: Nov. 13, 2003

(51) Int. Cl. E06B 1/04

(52) U.S. Cl. 52/204.1

(57) ABSTRACT

A modular coffer trim kit having a coffer module (4) and an inner trim (3). Each module (4) has a lowered (6) and raised (7) section so as to give a three-dimensional appearance when secured to a ceiling or wall. The modules (4) and trims come in various sizes and shapes so as to give the user a choice in designs. Additionally, the user can attach an outer trim (2) to the module (4) and inner trim (3) to achieve a more sophisticated look. Ornaments (5) can be attached to the inner trim (3) to give a more unique look. The entire kit is made of a lightweight material, preferably pine wood, so as to make one-person installation quick and easy. Additionally, the modules (4) and trims (2) and (3) can be directly secured to a surface, such as a ceiling or wall, by using fasteners such as butterfly bolts.

### BACKGROUND OF THE INVENTION

This invention relates to trim kits and, more particularly, a grid-less and framework-less modular coffer trim kit which is directly securable to a ceiling or wall.

Installing a coffer ceiling or wall into a home or office is currently very costly for the average consumer because the amount of time and labor required for installation. The current process of installing a coffer ceiling or wall requires the following steps: (1) builders cutting a “tray” (recess) into the ceiling or wall; (2) building a framework to fit within the tray; (3) constructing each molding to fit within the framework and (4) securing the framework to the ceiling or wall. Because the framework with the attached moldings is so large, several people are needed to assist in the securing process. In addition, the height of the ceiling or wall and the size of the coffer ceiling or wall desired increases the installation time and difficulty dramatically, which also increases the amount of money charged to the property owner for time and labor.

This invention provides a novel modular coffer trim kit for use by the average property owner. It is grid-less, framework-less, lightweight and directly attachable to a ceiling or wall, thus drastically reducing stress, time, labor and cost in comparison to the conventional coffered trim installation process.

The prior includes the following United States patents:

| U.S. Pat. No. | Inventor | Filing Date | Issue Date |
|---|---|---|---|
| 4,175,360 | Mulvey | May 02, 1977 | Nov. 27, 1979 |
| 3,848,385 | Thompson | Jun. 12, 1970 | Nov. 19, 1974 |
| 4,772,161 | Young | Apr. 29, 1982 | Feb. 02, 1988 |
| 3,685,238 | Fisher et al. | May 06, 1970 | Aug. 22, 1972 |
| 5,239,801 | Adams | Aug. 07, 1992 | Aug. 31, 1993 |
| 4,926,606 | Hanson | Nov. 14, 1988 | May 22, 1990 |
| 3,319,389 | Levine | Aug. 04, 1964 | May 16, 1967 |
| 4,189,888 | Blitzer, Jr. | Mar. 02, 1978 | Feb. 26, 1980 |

None of the above patents disclose a grid-less and framework-less modular trim kit which is directly securable to a ceiling or wall.

### SUMMARY OF THE INVENTION

The primary object of this invention is to provide a modular coffer trim kit which is easy to install, perhaps even by a single person.

A further object of the present invention is to provide a modular coffer trim kit which is lightweight.

Another object of the present invention is to provide a modular coffer trim kit which is aesthetically pleasing.

An even further object of the present invention is to provide a modular coffer trim kit which is inexpensive to the average consumer.

Another object of the present invention is to provide a modular coffer trim kit which does not require a framework for installation.

An even further object of the present invention is to provide a modular coffer trim kit which is directly securable to a ceiling or wall.

Another object of the present invention is to provide a modular coffer trim kit which can surround other wall hangings, such as plasma screen televisions and speakers.

The present invention fulfills the above and other objects by providing a modular coffer trim kit which is grid-less and framework-less and directly securable to a ceiling or wall. The modular coffer trim kit is preassembled so as to eliminate the need for building the trim on the property. The kits are made of a lightweight wood, preferably pine, and come in a variety of shapes. Because a framework is not needed, even a single person can install the entire coffer ceiling or wall themselves in a fraction of the time. The trim kit could be used to create a decorative effect on a ceiling or wall. It could also be used to give a more sophisticated appearance to other hanging wall objects, such as a plasma screen televisions and speakers, by giving a shelf-like finish.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is bottom view of a first embodiment of the present invention;

FIG. 2 is an upward perspective view of a second embodiment of the present invention installed on a ceiling;

FIG. 3 is an upward perspective view of a third embodiment of the present invention installed on a ceiling;

FIG. 4 is an upward perspective view of a fourth embodiment of the present invention installed on a ceiling; and

FIG. 5 is a frontal view of a fifth embodiment of the present invention installed on a wall.

### DESCRIPTION OF PREFERRED EMBODIMENT

Listed numerically below with reference to the drawings are terms used to describe features of this invention. These terms and numbers assigned to them designate the same features throughout this description.
1. modular coffer trim kit
2. outer trim
3. inner trim
4. coffer module
5. ornament
6. lowered section of module
7. raised section of module
8. plasma screen television
9. speaker
10. shelf
11. pre-cut hole
12. door
13. light

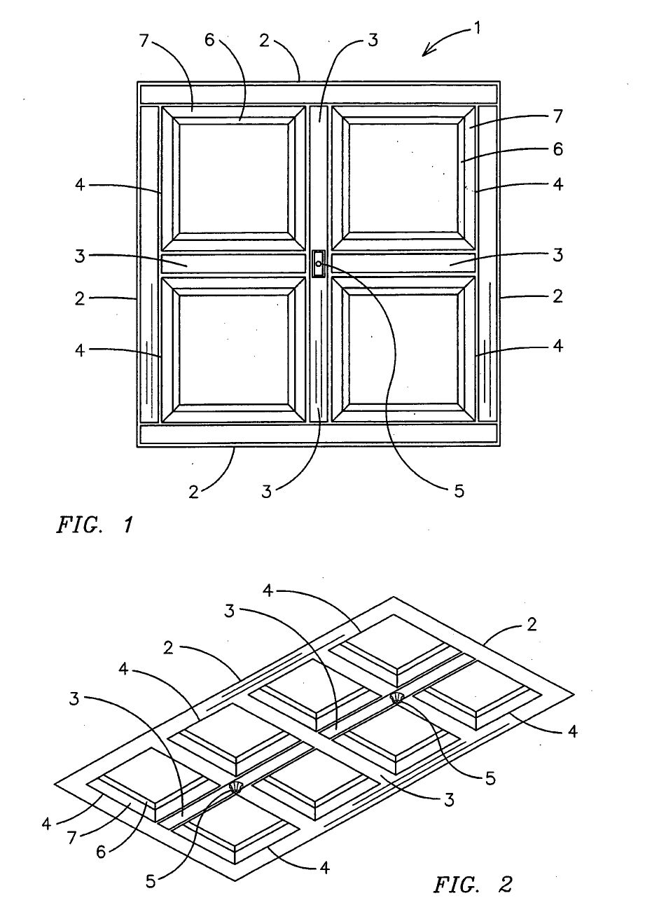

Referring to FIG. 1, a first embodiment of a modular coffer trim kit 1 is shown. The kit 1 includes an outer trim 2, an inner trim 3, coffer modules 4 and ornaments 5. The pre-assembled kit 1 is packaged with the inner trim 3 connected to the coffer modules 4 having a lowered section 6 and a raised section 7 in order to give a three-dimensional appearance when affixed to a structure. Ornaments 5 are then added as desired by the user. The user can either affix the lowered section of the modules 6 directly to a ceiling or a wall at this point or, for a more sophisticated look, use the outer trim 2 to surround all the modules 4 and then proceed to affix the structure to a ceiling or a wall. Because the entire kit 1 is made of a light wood, preferably pine, one person is capable of coffering an entire ceiling quickly and easily. To secure the modules 4, a user simply places the lowered section of the modules 6 in the desired location and secures it to the ceiling using a fastener, preferably by using a butterfly bolt.

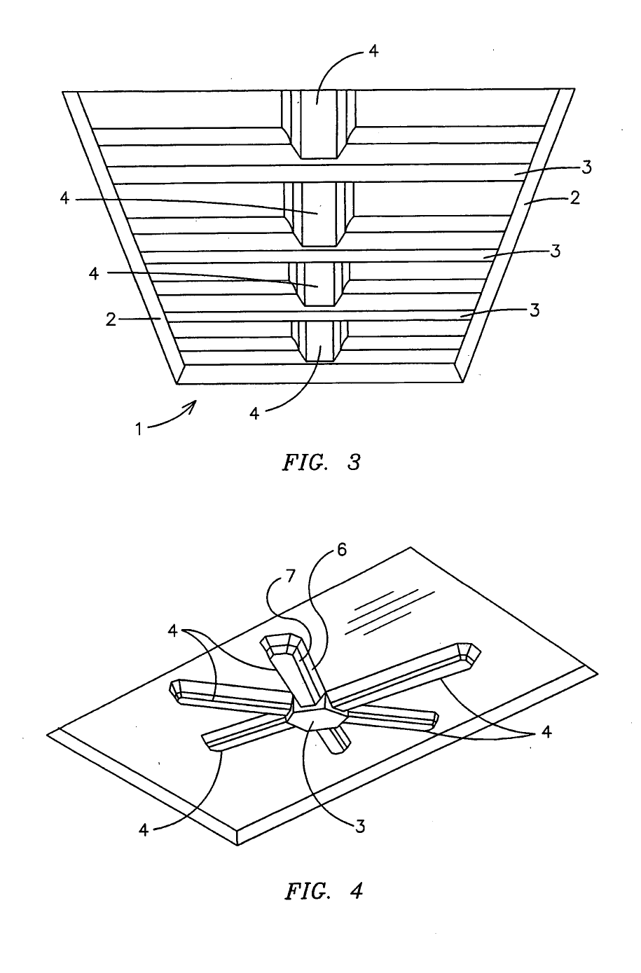

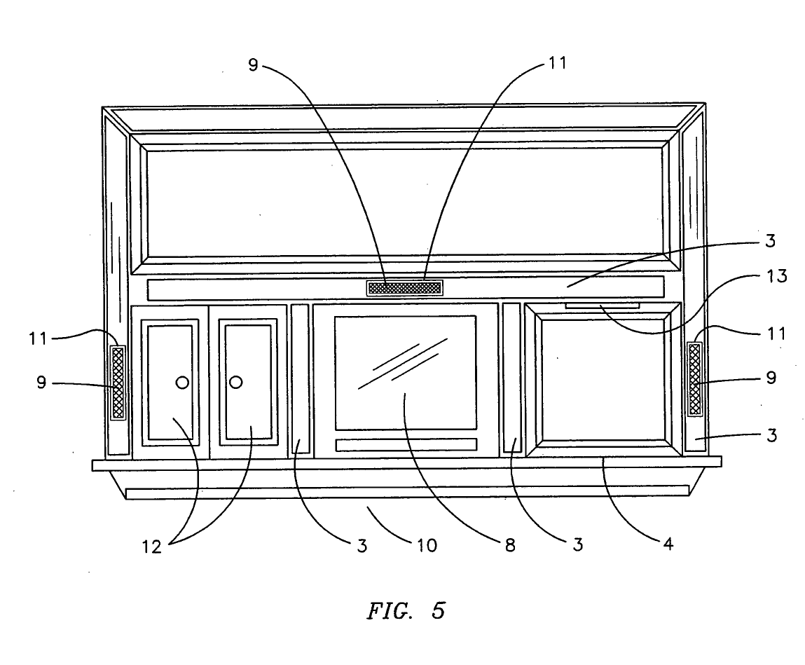

With reference to FIGS. 2-4, second, third and fourth embodiments of the present invention having the same components already discussed in relation to FIG. 1 are shown installed on ceilings.

In FIG. 5, a fifth embodiment of the present invention having the same components already discussed in relation to FIG. 1 is shown installed on a wall. The user simply positions the inner trim 3 connected to the coffer modules 4 against the wall to achieve the desired appearance and then secures the modules 4 directly to the wall. Some of the inner trims 3 have pre-cut holes 11 to surround pre-hung speakers 9. A coffer module 4 can have an opening large enough to frame a plasma screen television 8. Optional doors 12 can be affixed to the modules 4. Additionally, shelves 10 and lights 13 can be secured to the wall for a more sophisticated appearance.

Because the kit 1 eliminates the need for a grid and framework, less time and expense is required for the installation of a coffer ceiling.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A modular coffer trim kit comprising:
at least one coffer module having a predetermined shape;
said module having at least one side;
said module having a lowered section attached to said side;
said module having a raised section attached to said lowered section;
said module side is attached to an inner trim;
said inner trim having a predetermined shape; and
said coffer module attached to said inner trim is directly securable to a surface.

2. The modular coffer trim kit of claim 1 wherein:
said module and said inner trim are pine wood.

3. The modular coffer trim kit of claim 1 wherein:
ornaments are attached to said inner trim.

4. The modular coffer trim kit of claim 1 wherein:
said raised section of the module is square;
said lowered section of said module is square; and
said lowered section of said module is slightly larger than said raised section.

5. The modular coffer trim kit of claim 1 wherein:
said raised section of said module is rectangular;
said lowered section of said module is rectangular; and
said lowered section of said module is slightly larger than said raised section.

6. The modular coffer trim kit of claim 1 wherein:
said raised section of said module is circular;
said lowered section of said module is circular; and
said lowered section of said module is slightly larger than said raised section.

7. The modular coffer trim kit of claim 1 wherein:
said raised section of said module is triangular;
said lowered section of said module is triangular; and
said lowered section of said module is slightly larger than said raised section.

8. The modular coffer trim kit of claim 1 wherein:
an outer trim is attached to said modules and said inner trim so as to surround said modules and said inner trim.

9. The modular coffer trim kit of claim 8 wherein:
ornaments are attached to said outer trim.

10. The modular coffer trim kit of claim 1 wherein:
said surface is a ceiling.

11. The modular coffer trim kit of claim 1 wherein:
said surface is a wall.

12. The modular coffer trim kit of claim 1 wherein:
said lowered section of said module is secured to a surface using a butterfly bolt.

13. The modular coffer trim kit of claim 1 wherein:
said inner trim has at least one pre-cut hole.

14. The modular coffer trim kit of claim 13 wherein:
said at least one pre-cut hole is square.

15. The modular coffer trim kit of claim 13 wherein:
said at least one pre-cut hole is rectangular.

16. The modular coffer trim kit of claim 13 wherein:
said at least one pre-cut hole is circular.

17. The modular coffer trim kit of claim 13 wherein:
said at least one pre-cut hole is triangular.

18. The modular coffer trim kit of claim 1 wherein:
said inner trim has at least one detachable door.

19. The modular coffer trim kit of claim 1 wherein:
said trim kit has at least one shelf directly attachable to a surface.

20. The modular coffer trim kit of claim 1 wherein:
said inner trim has attachable lights.

21. The modular coffer trim kit of claim 4 wherein:
said inner trim shape is square.

22. The modular coffer trim kit of claim 4 wherein:
said inner trim shape is rectangular.

23. The modular coffer trim kit of claim 4 wherein:
said inner trim shape is circular.

24. The modular coffer trim kit of claim 4 wherein:
said inner trim shape is triangular.

25. The modular coffer trim kit of claim 5 wherein:
said inner trim shape is square.

26. The modular coffer trim kit of claim 5 wherein:
said inner trim shape is rectangular.

27. The modular coffer trim kit of claim 5 wherein:
said inner trim shape is circular.

28. The modular coffer trim kit of claim 5 wherein:
said inner trim shape is triangular.

29. The modular coffer trim kit of claim 6 wherein:
said inner trim shape is square.

30. The modular coffer trim kit of claim 6 wherein:
said inner trim shape is rectangular.

31. The modular coffer trim kit of claim 6 wherein:
said inner trim shape is circular.

32. The modular coffer trim kit of claim 6 wherein:
said inner trim shape is triangular.

33. The modular coffer trim kit of claim 7 wherein:
said inner trim shape is square.

34. The modular coffer trim kit of claim 7 wherein:
said inner trim shape is rectangular.

35. The modular coffer trim kit of claim 7 wherein:
said inner trim shape is circular.

36. The modular coffer trim kit of claim 7 wherein:
said inner trim shape is triangular.

37. The modular coffer trim kit of claim 8 wherein:
said outer trim is pine wood.

38. A method for installing a modular coffer trim kit comprising the steps of:
a. taking at least one coffer module having a predetermined shape;
b. affixing said module to an inner trim; and
c. securing said module affixed to said inner trim onto a surface.

39. The method claimed in claim 38 wherein:
said module affixed to said inner trim is secured to a surface using a butterfly bolt.

40. The method claimed in claim 38 wherein:
said surface is a wall.

41. The method claimed in claim 38 wherein:
said surface is a ceiling.

42. The method claimed in claim 38 wherein:
said inner trim has at least one pre-cut hole.

43. The method claimed in claim 38 further comprising a step prior to step c of:
affixing an outer trim around said module and said inner trim.

44. The method claimed in claim 38 further comprising a step prior to step c of:
affixing ornaments on said inner trim.

45. The method claimed in claim 42 further comprising a step prior to step c of:
affixing ornaments on said inner trim.

46. The method claimed in claim 38 comprising an additional step of:
securing a shelf onto a surface.

47. The method claimed in claim 38 further comprising an additional step of:
hanging an object within a module.

48. The method claimed in claim 46 further comprising an additional step of:
hanging an object within a module.

49. The method claimed in claim 47 further comprising an additional step of:
hanging an object within said at least one inner trim hole.

50. The method in claim 48 further comprising an additional step of:
hanging an object within said at least one inner trim hole.
